(19) United States
(12) Patent Application Publication
(10) Pub. No.: US 2004/0182955 A1
(43) Pub. Date: Sep. 23, 2004

(54) Roller grinding mill and method for grinding materials that contain magnetizable components

(76) Inventor: Hartmut Kronz, Hückelhoven (DE)

Correspondence Address: JACOBSON HOLMAN PLLC, 400 SEVENTH STREET N.W., SUITE 600, WASHINGTON, DC, 20004, US

(21) Appl. No.: 10/483,401

(22) PCT Filed: Jul. 25, 2002
(86) PCT No.: PCT/EP02/08309

(30) Foreign Application Priority Data
Aug. 23, 2001 (DE) 101 41 414.5

(51) Int. Cl. B02C 19/00

(52) U.S. Cl. 241/24.14; 241/79.1

(57) ABSTRACT

The invention relates to a roller mill, particularly an air-swept roller mill provided with a device for separating magnetizable constituents, particularly iron particles from the milling area.

The invention also relates to a method for grinding materials with magnetizable, particularly iron-containing constituents, e.g. slag, in an air-swept roller mill where, for avoiding concentrations of magnetizable particles, particularly iron particles, on the grinding pan, said particles are electromagnetically separated and removed from the roller mill.

The invention relates to a roller mill according to the preamble of claim 1, particularly an air-swept roller mill according to the preamble of claim 4, and a method for grinding materials with magnetizable, particularly iron-containing constituents according to the preamble of claim 14.

The invention is preferably intended for slag mills and for grinding granulated blast furnace slag and for use in cement milling plants, where air-swept roller mills are used for grinding cement clinker, gypsum and granulated blast furnace slag (DE 39 21 986 C1).

Granulated blast furnace slag is obtained during the production of iron during the blast furnace process and contains iron particles, which in the milling or grinding process lead to relatively high wear to the components participating in said process.

In order to minimize wear, prior to crushing the feedstock is supplied to a magnetic separator, particularly an overbelt magnetic separator. However, this only removes constituents which are freely exposed and which are not enclosed by slag. Said constituents pass with the feedstock into the mill.

During the grinding process the iron particles are decomposed and concentrated as a result of their high specific gravity and poor millability on the grinding pan. A removal only takes place if said concentrated iron particles, as a result of centrifugal force, pass over the grinding pan edge and vane ring into the ring duct and from there into the external cycle for the so-called “external coarse particles”, where they are separated from the coarse particles by magnetic separating means.

Swiss patent 103 265 discloses a method for comminuting, crushing or squeezing out random materials, in which the elements, between which the milling material undergoes the treatment, are pressed against one another with magnetic force. A description is given of roller mills in which the pressure magnetically produced between the grinding rollers is intended to reduce bearing pressures and movable masses. In the presence of magnetic components in the milling material, the wear phenomena on the grinding rollers are to be eliminated automatically after they have arisen in that the magnetic components are attracted to the elevations and comminuted, so that a greater wear occurs there compared with that in the depressions. For the separation of magnetizable substances in the milling material, additionally at least one magnetizable separating roller is located upstream or downstream of the milling or grinding clearance and cooperates with one of the two grinding rollers.

To reduce the bearing pressures in roller mills, the construction of an annular magnetic field in the milling pan is proposed. A magnetic field is to be formed by two concentric ring poles and a field coil. The grinding rollers roll on the upper ring faces. A separation of magnetizable constituents from the grinding bed and a removal of said constituents from the grinding area separate from the finished material is not intended. The disadvantages of the presence of iron particles and similar magnetizable substances in the grinding bed and in the grinding and classifying area can consequently not be avoided.

The object of the invention is to provide a roller mill, particularly an air-swept roller mill, and a-method which in an extremely simple and efficient manner and without interrupting the grinding operation and whilst maintaining the product quality, ensure a removal of the iron constituents and further metal fractions from the milling material in the grinding area.

From the apparatus standpoint the object is achieved by the features of claims 1 and 4 and from the method standpoint by the features of claim 14. Appropriate and advantageous developments appear in the subclaims and the specific description relative to the drawings.

A fundamental idea of the invention is that magnetizable particles, particularly iron particles decomposed during comminution and present on the grinding pan in the grinding area, particularly in the grinding bed, are to be removed with the aid of at least one electromagnetic device located in the grinding area and a concentration of such particles on the milling bed is avoided by extracting the particles, which can in particular take place in a continuous manner.

According to the invention, the electromagnetic device is a roller-like device rolling on the grinding bed and which is constructed in such a way that the magnetizable, particularly iron particles of the grinding bed adhere to the surface. With the aid of a discharge mechanism, which is connected to the roller-like, electromagnetic device and cooperates therewith, the separated, magnetizable constituents are removed from the roller-like device and discharged from the grinding area. The use of at least one roller-like, electromagnetic device rolling on the grinding bed is advantageous for a troublefree, efficient grinding process due to the low frictional resistance and the simultaneously smoothing and compacting action.

In principle, the electromagnetic device can also be positioned above the grinding bed and provided with an adjustable gap between the jacket of the roller-like device and the grinding pan.

In roller mills, which are e.g. used as overflow mills and have no integrated classifier, a grinding roller can also be constructed for electromagnetic separation. Through the removal of the iron particles, which hereinafter is also understood to cover other magnetizable particles, wear to grinding rollers and grinding pans is reduced and the service life increased.

It is particularly advantageous to install at least one electromagnetic device in air-swept roller mills having at least one pair of rollers and in general two or three pairs of rollers. A pair of rollers comprises a grinding roller, also known as the master roller, as well as an auxiliary roller, also known as the slave roller and which is located upstream of the master roller and which prepares the grinding bed, particularly compacting and rendering the same uniform and which particularly with hard and brittle materials ensures an optimized, vibration-free milling.

It is appropriate to construct at least one slave roller for the electromagnetic separation of magnetizable constituents, particularly iron particles, from the grinding bed and to connect it to a discharge mechanism with which said disturbing constituents can be removed from the grinding area.

In an advantageous development the slave roller has a nonmagnetic roller jacket and in the interior a regulatable electromagnet, preferably with-an iron core and electrical coils, whose shaping and arrangements are adapted to the roller shape over a predetermined area of the roller jacket in order to build up an effective magnetic field. If, considered in circular cross-section, the iron core extends roughly over an angle between 240 and 270°, the necessary extraction and adhesion of the particles and the subsequent detachment and removal are ensured.

The current supply for the electrical coils appropriately takes place in the vicinity of the roller axis. In addition, for regulating the electromagnet a thyristor circuit is advantageously provided.

The discharge mechanism for removing the metal particles separated on the electromagnetic device and in particular the iron particles is appropriately constructed in such a way that the separated particles are continuously conveyed out of the milling area and can e.g. be fed by means of the vane ring into an area located below the same.

It is particularly advantageous to use a discharge mechanism having a stripper, a conveyor trough and a downcomer. The stripper can have a ledge-like construction and appropriately extends at least over the width of the rolling face of the electromagnetic device, e.g. the jacket of a slave roller. For a troublefree acceptance of the particles, it is also appropriate for the stripper to be arranged in parallel and at an adjustable distance from the roller jacket of the electromagnetically constructed slave roller.

Appropriately the stripper is fixed in detachable and/or vertically adjustable manner to the conveyor trough. In an alternative construction the stripper and conveyor trough form a unit. The conveyor trough with stripper arranged in the defined manner are then advantageously fixed in such a way that a height adjustment and a variation to the gap between the stripper and electromagnetic roller is possible.

In principle, the stripper and/or conveyor trough can be fixed to the mill casing.

However, for particularly efficient iron separation it is advantageous to fix to the slave roller with an electromagnet, e.g. in the vicinity of the rocking lever or roller axis. The stripper and/or conveyor trough then follow the movement of the slave roller and are moved up and down therewith on the grinding bed.

The conveyor trough appropriately has a gradient in the direction of an opening in the vane ring, so that the stripped particles are conveyed as a result of gravity action and, e.g. by means of a downcomer located in an opening in the vane ring, pass into the ring duct or an area below the vane ring.

To prevent a gas flow from the ring duct in the downcomer, it is appropriate to close the latter with a regulatable shutoff means. It is e.g. possible to install a weighted pendulum flap, which in the case of a predeterminable loading is swung up in the ring duct direction through dropped particles.

The inventive method for milling materials with magnetizable, particularly iron-containing constituents, e.g. slag, comprises in addition to an electromagnetic separation prior to the grinding process, a further electromagnetic separation takes place in the grinding area of a roller mill, particularly an air-swept roller mill, in order to extract the particles decomposed and left free during the grinding process and prevent a concentration of said particles on the grinding pan.

According to the invention electromagnetic separation is carried out in the grinding area with the aid of a roller-like device, particularly a slave roller. In addition to the grinding bed preparation, it is possible with at least one roller-like electromagnetic device rolling on the grinding bed and e.g. a slave roller provided with a regulatable electromagnet to bring about an extraction of the magnetizable particles, particularly iron particles from the grinding bed and grinding area. A continuous separation on the electromagnetically constructed slave roller can be performed in a particularly advantageous manner.

The particles separated on the electromagnetically constructed slave roller are then advantageously stripped with the aid of a corresponding discharge mechanism, supplied by means of the vane ring to the ring duct of the air-swept roller mill and discharged from the latter together with the coarse particles hurled over the grinding pan edge and entering the annular space and are mechanically conveyed, particularly with a revolving bucket conveyor to the feed mechanism, e.g. to a weighing belt for the feedstock. In order to separate the metal particles from the coarse particles, a further metal separation and in particular an electromagnetic separation takes place. The coarse particles are then generally returned together with the new feedstock to the air-swept roller mill.

Appropriately the electromagnetic device in the slave roller is regulated by means of a thyristor circuit and the mill is started up initially in a normal manner, i.e. without switching on the electromagnet, and only following the putting into operation of the control loop for the slave roller speed is the electromagnet switched on. In principle, the electromagnet can be regulated by means of the slave roller speed signal.

The advantages of the roller mill or air-swept roller mill according to the invention and the method according to the invention are that a continuous and regulatable separation of the magnetizable constituents, particularly the iron particles, can be carried out during the grinding process and removal from the grinding area can take place without interrupting milling operation.

When using an auxiliary or slave roller the advantage is that essentially existing component means can be used. As a result of the continuous separation and discharge from the grinding area and the area below the milling or grinding pan, there is overall a reduced external cycle and it is possible to make smaller the plant for the coarse particles to be returned, also known as the reject plant. In addition, the separated, discharged iron particles are suitable for use as a sand blasting material. Another important advantage is the avoidance of wear phenomena on the master rollers, slave rollers and on the grinding path, together with the repair costs, idle times, etc. associated therewith.

The invention is described in greater detail hereinafter relative to the diagrammatic drawings, wherein show:

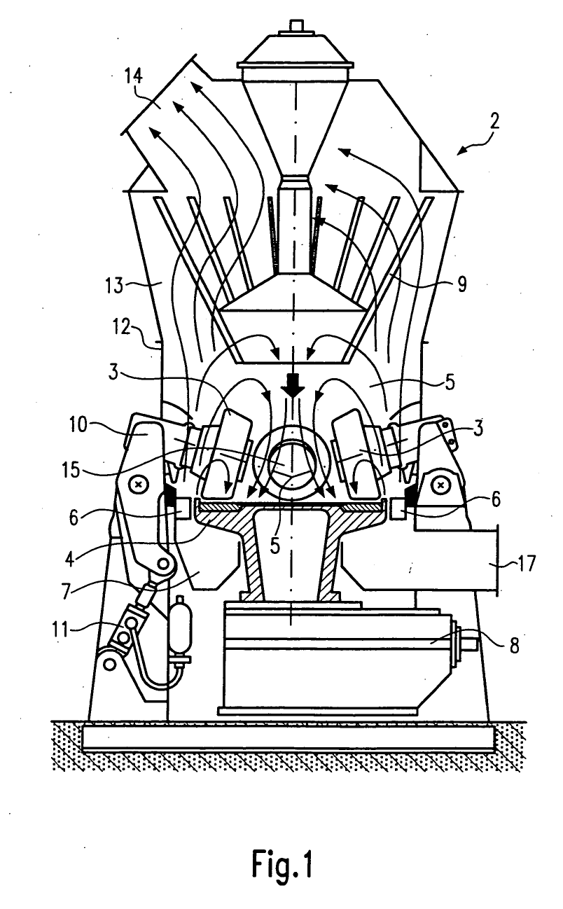

FIG. 1 An air-swept roller mill with an electromagnetically constructed slave roller.

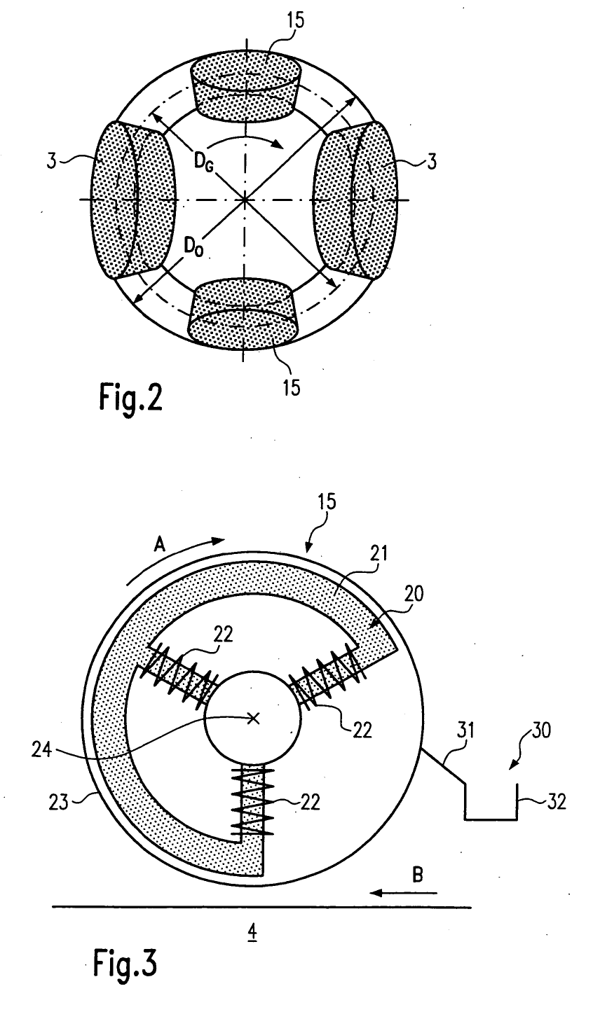

FIG. 2 A highly diagrammatic plan view of the grinding pan of the air-swept roller mill of FIG. 1.

FIG. 3 A highly diagrammatic cross-section through an electromagnetically constructed slave roller with discharge mechanism.

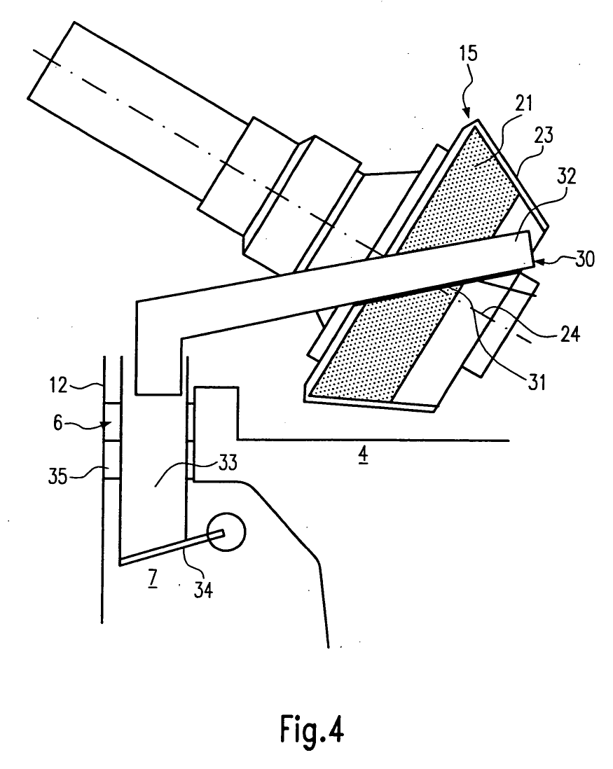

FIG. 4 A detail of an air-swept roller mill with an electromagnetically constructed slave roller and discharge mechanism.

FIG. 1 shows a LOESCHE air-swept roller mill 2, which is more particularly intended for the grinding of cement and granulated blast furnace slag and which is equipped with two roller pairs 3, 15. In order not to overcomplicate representation, FIG. 1 shows two grinding rollers 3, but only one auxiliary roller 15. However, FIG. 2 shows the two roller pairs, which in each case comprise one grinding roller or master roller 3 and one auxiliary roller or slave roller 15.

The master rollers 3 and slave rollers 15 roll on a grinding bed, which is formed by the feedstock on a grinding path of a rotating grinding pan 4. The grinding pan 4 is rotated by means of a drive 8 and is surrounded by a vane ring 6 by means of which a gas flow, particularly an air flow flows from a ring duct 7 into the milling area 5. The feedstock, e.g. blast furnace slag or a mixture of cement clinker, gypsum and slag, is fed by means of dosing or proportioning mechanisms, a magnetic separator and a not shown feed mechanism to the air-swept roller mill, then passes onto the grinding pan 4 and is comminuted between the resiliently pressed master rollers 3 and grinding pan 4. The air flowing into the milling area 5 through the vane ring 6 by means of a supply duct 17 and the ring duct 7 conveys the mixture of fine and coarse material into a classifying area 13 and into the vicinity of a classifier 9. Coarse material is rejected and drops back onto the grinding pan 4, whilst fine material is discharged by means of a fine material discharge 14. FIG. 1 also shows the mill casing 12, the rocking levers 10 of the two master rollers 3 and a hydraulic cylinder mechanism 11 in the case of the left-hand master roller 3, which brings about the resilient pressing action of said master rollers 3.

In the embodiment according to FIGS. 1 and 2, the slave rollers 15 have a smaller diameter than the master rollers 3 and unlike the latter are not subject to a force and instead rest under their own weight on the milling bed leading to a purely rolling movement or a rolling movement superimposed by a planned sliding action. Each slave roller 15 prepares the milling bed for the master roller 3 located behind the slave roller 15 considered in the rotation direction of the milling pan 4 and this leads to the comminution of the milling material.

Reference is made to German patent 39 21 986 regarding the construction, arrangement and action of the slave rollers.

FIG. 2 shows that the slave roller 15, like the master rollers 3, has a conical construction and the width thereof roughly corresponds to the grinding path width.

At least one slave roller 15 is constructed for the electromagnetic separation of magnetizable fractions, particularly iron fractions, from the grinding material to be comminuted, in order to prevent concentration of said constituents on the grinding pan 4 and the associated wear to the milling means.

FIG. 3 shows in cross-section a slave roller 15 constructed for electromagnetic separation. Arrow A indicates the rotation direction of slave roller 15 and arrow B the direction of the rotating grinding pan 4. The grinding material to be comminuted or the grinding bed is not shown. The slave roller 15 has a roller jacket 23 made from nonmagnetic material and is internally provided with an iron core 21 and electrical coils 22. The iron core 21 is adapted to the conically constructed roller jacket 23 of the slave roller 15 and, considered in cross-section, roughly extends over two thirds of the shell surface, so that the metal, particularly iron particles to be removed, are received from the grinding bed on the grinding pan 4 and, adhering to the rotating roller jacket 23, are conveyed to a discharge mechanism 30. The discharge mechanism 30 can be seen in FIG. 4. FIG. 3 shows a stripper 31 and a conveyor trough 32 in highly diagrammatic form.

The electromagnetic device 20 in the interior of the slave roller 15 has three electrical coils 22 arranged radially with an angular distance of approximately 120° and together with the iron core 21 form the stationary electromagnet through which the iron particles on the milling pans are attracted and, adhering to the rotary roller jacket 23, are passed to a magnet-free area and the discharge mechanism 30 positioned there.

It is also possible to construct the electromagnetic device 20 and roller jacket 23 as a rotary unit and as a function of the magnetic field strength to so construct and position the stripper that a release of particles is ensured.

FIG. 4 shows the conically shaped iron core 21 close to the roller jacket 23 of the slave roller 15 and the arrangement of the stripper 31 on the conveyor trough 30. The stripper 31 has a ledge-shaped construction and is fixed to the conveyor trough 32 in parallel and with a limited spacing from the roller jacket 23.

The conveyor trough 32 has a slight gradient in the direction of the mill casing 12 or vane ring 6 and issues into a downcomer 33. The downcomer is located in an opening 35 of the vane ring 6 and extends up to the ring duct 7. Fixing of the downcomer 33 can take place by means of fixing elements in the vicinity of neighbouring vanes of the vane ring 6 or to the mill casing 12. At the lower end the downcomer 33 is provided with a closing flap 34 constructed as a weighted pendulum flap.

The magnetized particles and in particular iron particles separated on slave roller 15 are only retained in the vicinity of the iron core 21 and subsequently pass via stripper 31 into the conveyor through 32, then into the downcomer 33 and ring duct 7. The coarse material particles not picked up by the master rollers 3 for comminuting purposes and which have not passed in the air flow to the classifier 9 collect in the ring duct 7 or a space below the milling area.

Together with said coarse particles, the separated iron particles are discharged from the air-swept roller mill 2 and are generally separated from the coarse particles on a weighing belt with metal separator, which is supplied again to the air-swept roller mill together with the new feedstock (not shown).

1. Roller mill, comprising
a milling area (5) in which at least one grinding roller (3) rolls on a grinding path of a grinding pan (4) and an electromagnetic device (20) for separating magnetizable constituents, particularly iron particles from the grinding material is provided,
characterized in that
the electromagnetic device (20) has a roller-like construction and rolls on the grinding bed and
that the electromagnetic device (20) is connected to a discharge mechanism (30) for removing the separated, magnetizable constituents, particularly the iron particles from the milling area (5).

2. Roller mill according to claim 1,
characterized in that
a grinding roller (3) is constructed for electromagnetic separation and is provided with an electromagnetic device (20).

3. Roller mill according to claim 1,
characterized in that
the roller-like, electromagnetic device (20) is positioned with an adjustable gap between the jacket of the roller-like, electromagnetic device and the grinding path.

4. Air-swept roller mill, comprising
a rotary grinding pan (4), a vane ring (6) located between the grinding pan (4) and the mill casing (12), a ring duct (7) below the vane ring (6) and an integrated classifier (9) above the milling area (5), at least one grinding roller (3) mounted in rotary manner and which can be resiliently pressed against grinding material on the grinding path of the grinding pan (4), and at least one slave roller (15),
characterized in that
the slave roller (15) is constructed for separating magnetizable constituents, particularly iron particles from the milling area (5) and provided with an electromagnetic device (20) and that a discharge mechanism (30) is provided for removing the magnetizable constituents, particularly the iron particles from the slave roller (15) and for discharging the same from the milling area (5).

5. Air-swept roller mill according to claim 4,
characterized in that
the slave roller (15) has a nonmagnetic roller jacket (23) and as the electromagnetic device (20) a regulatable electromagnet with an iron core (21) and electrical coils (22) are located in the interior of the slave roller (15).

6. Air-swept roller mill according to claim 5,
characterized in that
the power supply for the electrical coils (22) takes place in the vicinity of the roller axis (24) and for regulating the electromagnetic device (20) a thyristor circuit is provided.

7. Air-swept roller mill according to one of the claims 4 to 6,
characterized in that
as the discharge mechanism (30) are provided at least one stripper (31), a conveyor trough (32) and a downcomer (33).

8. Air-swept roller mill according to claim 7,
characterized in that
the stripper (31) has a ledge-shaped construction and is positioned virtually parallel to the roller jacket (23) of the slave roller (15) on the conveyor trough (32) and that the conveyor trough (32) extends roughly to the vane ring (6).

9. Air-swept roller mill according to claim 8,
characterized in that
an opening (35) is formed in the vane ring (6) and that the downcomer (33) extends through said opening (35) and connects the conveyor trough (32) to the ring duct (7).

10. Air-swept roller mill according to one of the claims 7 to 9,
characterized in that
a closing flap (34) for the gas flow from the ring duct (7) is provided in the downcomer (33).

11. Air-swept roller mill according to claim 10,
characterized in that
the closing flap (34) in the downcomer (33) is a weighted pendulum flap.

12. Air-swept roller-mill according to one of the claims 7 to 11,
characterized in that
at least the stripper (31) and/or the conveyor trough (32) are arranged in vertically adjustable manner.

13. Air-swept roller mill according to one of the claims 7 to 12,
characterized in that
at least the stripper (31) and/or the conveyor trough (32) are fixed to the roller axis (24) or the rocking lever (10) of the slave roller (15).

14. Method for milling materials with magnetizable, particularly iron-containing constituents, e.g. slag, in which the feedstock, following the separation of the magnetizable constituents, particularly iron constituents, is supplied to an air-swept roller mill and is comminuted therein,
characterized in that
in the milling area is carried out a further electromagnetic separation, the magnetizable particles, particularly the iron particles, decomposed during comminution being continuously separated on a roller-shaped, electromagnetic device rolling on the grinding bed, after which stripping takes place from the roller-shaped, electromagnetic device, followed by discharge from the air-swept roller mill via the vane ring and annular space.

15. Method according to claim 14,
characterized in that
the magnetizable particles, particularly the iron particles adhering to the roller-shaped, electromagnetic device are mechanically stripped and, utilizing the gravity action, e.g. in a conveyor trough are supplied to the annular space.

16. Method according to claim 14 or 15,
characterized in that
the magnetizable particles, particularly iron particles, and the coarse particles passing over the grinding pan edge into the annular space below the vane ring, are mechanically discharged from the annular space and conveyed in a conveyor to the feedstock, before which in an electromagnetic separation operation the magnetizable particles, particularly iron particles are separated and the remaining coarse particles are supplied for regrinding to the feedstock.

17. Method according to one of the claims 14 to 16,
characterized in that
as roller-shaped; electromagnetic device is used a grinding/master roller or an auxiliary slave roller and the electrical lines are guided in the vicinity of the roller axis.

18. Method according to one of the claims 14 to 17,
characterized in that
the electromagnetic device is controlled by means of a thyristor circuit.

19. Method according to claim 17 or 18,
characterized in that
when using a slave roller, the roller mill is initially started and the electromagnetic device is switched on as a function of the control loop for the slave roller speed.

20. Method according to claim 19,
characterized in that
the electromagnetic device is controlled by means of the slave roller speed signal.
